(19) United States
(12) Patent Application Publication
(10) Pub. No.: US 2006/0279774 A1
(43) Pub. Date: Dec. 14, 2006

(54) Method and apparatus for providing device information

(75) Inventors: Naoki Matsuoka, Kawasaki (JP); Haruyuki Takeyoshi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/232,388

(22) Filed: Sep. 21, 2005

(30) Foreign Application Priority Data
Jun. 9, 2005 (JP) 2005-170167

(51) Int. Cl. G06F 3/12

(52) U.S. Cl. 358/1.15

(57) ABSTRACT

An apparatus for providing device information on devices arranged on a network includes a registering unit, a discovering unit, a database, and a providing unit. The registering unit is configured to register device information on a first device that does not support an automatic discovery scheme with which a device on the network is automatically discovered. The discovering unit is configured to discover a second device that supports the automatic discovery scheme and to obtain device information on the second device. The database is configured to store the device information. The providing unit is configured to provide the device information on the first device to the second device.

### CROSS-REFERENCE TO RELATED APPLICATIONS

This application is based upon and claims the benefit of priority from the prior Japanese Patent Application No. 2005-170167, filed on Jun. 9, 2005, the entire contents of which are incorporated herein by reference.

### BACKGROUND OF THE INVENTION

1. Field of the Invention

The present invention relates to a method and apparatus for providing device information with which information on devices arranged on an in-home network is obtained to be provided to each of the devices.

2. Description of the Related Art

Recently, along with networking of devices, such as a personal computer (PC), an audiovisual (AV) equipment and white goods, an in-home network in an ordinary household has been being developed. To use a service provided through a network with the devices in such in-home network, it is necessary to obtain information on a service provider such as an internet protocol (IP) address. Conventionally, information on the devices to be connected has been obtained by a user.

FIG. 15 is a schematic for illustrating a structure in which device information is automatically obtained. There is a method of obtaining information on devices A to D arranged on an in-home network 110, as shown in FIG. 15, based on a universal-plug-and-play (UPnP) automatic-device-discovery protocol (UPnP device architecture). The devices A and B that are provided with the UPnP automatic-device-discovery protocol can detect each other by automatically exchanging an automatic-discovery protocol message.

When various kinds of automatic-discovery protocols are used, a protocol gateway (GW) 1510 is provided so that information on devices having different protocols can be automatically obtained (For example, Japanese Patent Publication No. 2003-501765). Different automatic-discovery protocols are mutually converted by the protocol gateway 1510. Thus, device information of the devices A and B provided with the automatic-discovery protocols, such as a UPnP device or an HAVi device, can be automatically obtained.

However, in reality, very few devices are provided with such automatic-discovery protocols and most of home appliances are not provided with the automatic-discovery protocols. Therefore, the devices A and B cannot obtain information of the devices C and D, which are ones of most of devices that are not provided with the automatic-discovery protocols in a house. Moreover, the devices C and D cannot obtain information on any other device including the devices A to D because no function of obtaining the information is provided.

As another method to obtain the device information, the device information on the devices A to D are manually input and made accessible on a web based server. However, if there is a change in a condition of the devices A to D, wrong information is provided until the device information is updated by manual correction.

AS described above, in the conventional technologies, it is difficult for the devices A to D on the in-home network 110 to obtain information of all of the devices A to D including the latest device information.

### SUMMARY OF THE INVENTION

It is an object of the present invention to at least solve the problems in the conventional technology.

An apparatus according to one aspect of the present invention is for providing device information on devices arranged on a network and includes a registering unit configured to register device information on a first device that does not support an automatic discovery scheme with which a device on the network is automatically discovered; a discovering unit configured to discover a second device that supports the automatic discovery scheme, and to obtain device information on the second device; and a providing unit configured to provide the device information on the first device, to the second device.

A method according to another aspect of the present invention is for providing device information on devices arranged on a network and includes registering device information on a first device that does not support an automatic discovery scheme with which a device on the network is automatically discovered; discovering a second device that supports the automatic discovery scheme; obtaining device information on the second device; and providing the device information on the first device, to the second device.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an apparatus for providing device information according to a first embodiment of the present invention;

FIG. 2 is a table of device information stored in a device information database;

FIG. 3 is a sequence diagram of an operation to record and provide the device information according to the first embodiment;

FIG. 4 is a schematic for illustrating the device information;

FIG. 5 is a schematic of an apparatus for providing device information according to a second embodiment of the present invention;

FIG. 6 is a sequence diagram of an operation to record and provide the device information according to the second embodiment;

FIG. 7 is a table of device information stored in the device information database;

FIG. 8 is a sequence diagram of an operation to record and provide the device information according to a third embodiment of the present invention;

FIG. 9 is a flowchart of an address monitoring process according to a fourth embodiment of the present invention;

FIG. 10 is a sequence diagram of an operation to update the device information according to the fourth embodiment;

FIG. 11 is a schematic for illustrating update of information in the device information database;

FIG. 12 is a schematic of an apparatus for providing device information according to a fifth embodiment of the present invention;

FIG. 13 is a sequence diagram of an operation to record and provide the device information according to the fifth embodiment;

FIG. 14 is a schematic of an apparatus for providing device information according to a sixth embodiment of the present invention; and

FIG. 15 is a schematic for illustrating a structure in which the device information is automatically obtained.

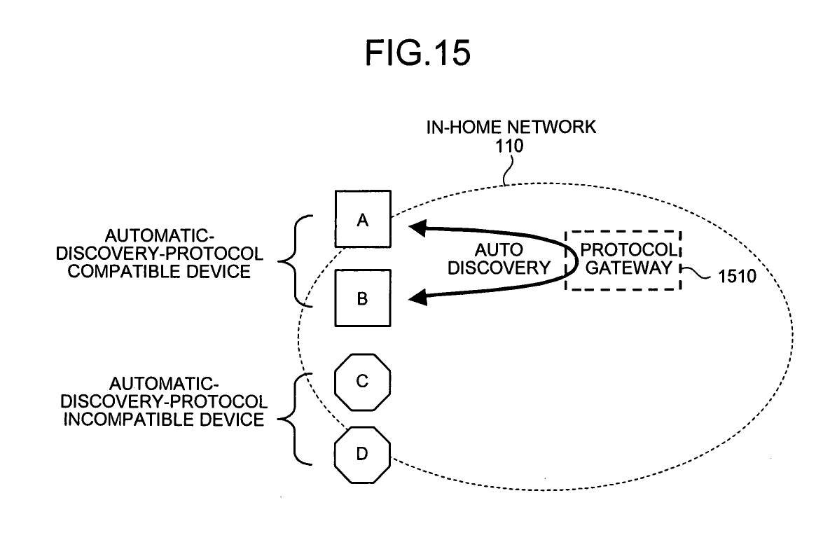

### DETAILED DESCRIPTION OF THE PREFERRED EMBODIMENTS

Exemplary embodiments according to the present invention are explained in detail below with reference to the accompanying drawings.

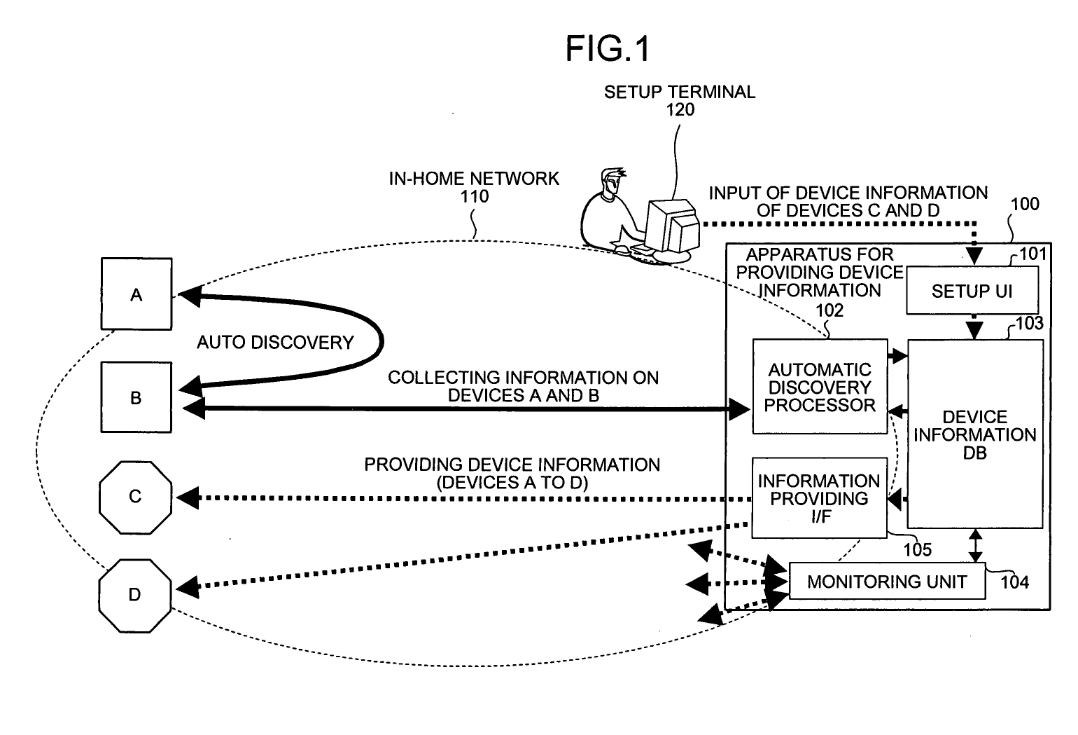

FIG. 1 is a schematic of an apparatus for providing device information according to a first embodiment of the present invention. On the in-home network 110, devices A and B that are compatible with an automatic discovery protocol, for example, the UPnP protocol, and devices C and D that are incompatible with the automatic discovery protocol are arranged. Besides, an apparatus for providing device information 100 is separately arranged on the in-home network 110. A setup terminal 120 that inputs device information into the apparatus 100 is connected to the apparatus 100.

The apparatus 100 provides device information to each of the devices A, B, C, and D on the in-home network 110. A setup user interface (setup UI) 101 is an interface to manually set and record, from the setup terminal 120, device information of the devices C and D. An automatic discovery processor 102 automatically obtains device information of the devices A and B based on the automatic discovery protocol and provides the device information.

A device information database (device information DB) 103 collectively manages the device information recorded via the setup UI 101 and the device information obtained by the automatic discovery processor 102. The device information on each of the devices A, B, C, and D is stored in the device information DB 103. A monitoring unit 104 periodically monitors correctness of the device the information stored in the device information DB 103. When a change is found in the device information, the monitoring unit 104 updates the device information in the device information DB 103 to the latest information.

An information providing interface (I/F) 105 is an interface through which the device information in the device information DB 103 is referred from an external devices, for example, the devices A, B, C, D, and provided to the external devices.

The apparatus 100 collectively controls the device information of all the devices A, B, C, and D on the in-home network 110. To provide the device information to the devices A and B, the automatic discovery processor 102 advertises the device information of the devices C and D to the in-home network 110 based on the UPnP protocol. Thus, the devices A and B obtain the device information of the devices C and D.

On the other hand, to provide the device information to the devices C and D, it is configured such that the devices C and D can access the device information DB 103 via the information providing I/F 105. For example, if a web server interface is used as the information providing I/F 105, the devices C and D can obtain the device information of all the devices A to D managed in the apparatus 100 by accessing a uniform resource locater (URL) of the information providing I/F 105 from a browser of the devices C and D. A method of providing the device information to the devices C and D is not limited to a method using the web server, and if the devices C and D has a specific information obtaining function, the apparatus 100 can also provide the device information in a format suitable for specifications of such a function.

Thus, the apparatus 100 provides the device information of all the devices A to D, to both the devices A and B, which are automatic discovery protocol compatible, and the devices C and D, which are automatic discovery protocol incompatible. Moreover, the monitoring unit 104 monitors the correctness of the device information in the device information DB 103 and obtains the latest device information. Thus, the device information DB 103 always stores the latest device information, thereby providing the latest device information to the devices A to D on the in-home network 110 without manual operation.

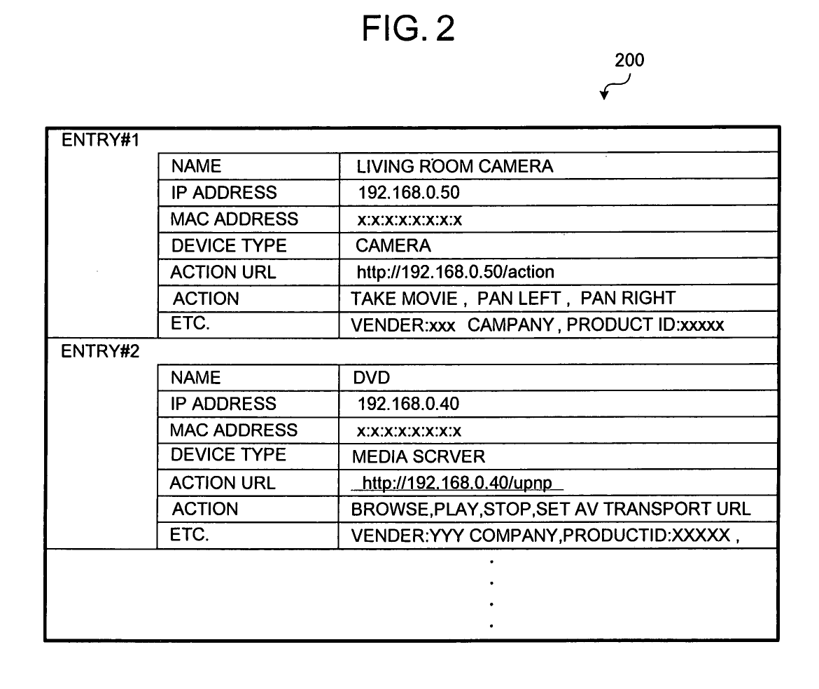

FIG. 2 is a table of the device information stored in the device information DB 103. Device information 200 for includes a device name (name), a network address (IP address, medium access control (MAC) address), a device type (device type), a control URL (action URL), a control/function entry (actions), remarks (for example, name of a manufacturer and a model number). The device information 200, which is input via the setup UI 101, is stored in the device information DB 103.

The automatic discovery processor 102 discovers the device B based on the automatic discovery protocol, obtains the device information and service information of the device B discovered, and records the device information and the service information in the device information DB 103. The device information includes items shown in FIG. 2. Thus, the apparatus 100 collectively controls and grasps the devices A and B, which are UPnP compatible and the devices C and D, which are UPnP incompatible, on the in-home network 110.

To explain an operation to provide the device information, the device B is taken as an example of an automatic-discovery-protocol (UPnP) compatible device, and the device C is taken as an example of an automatic-discovery-protocol (UPnP) incompatible device, for the conveniences sake.

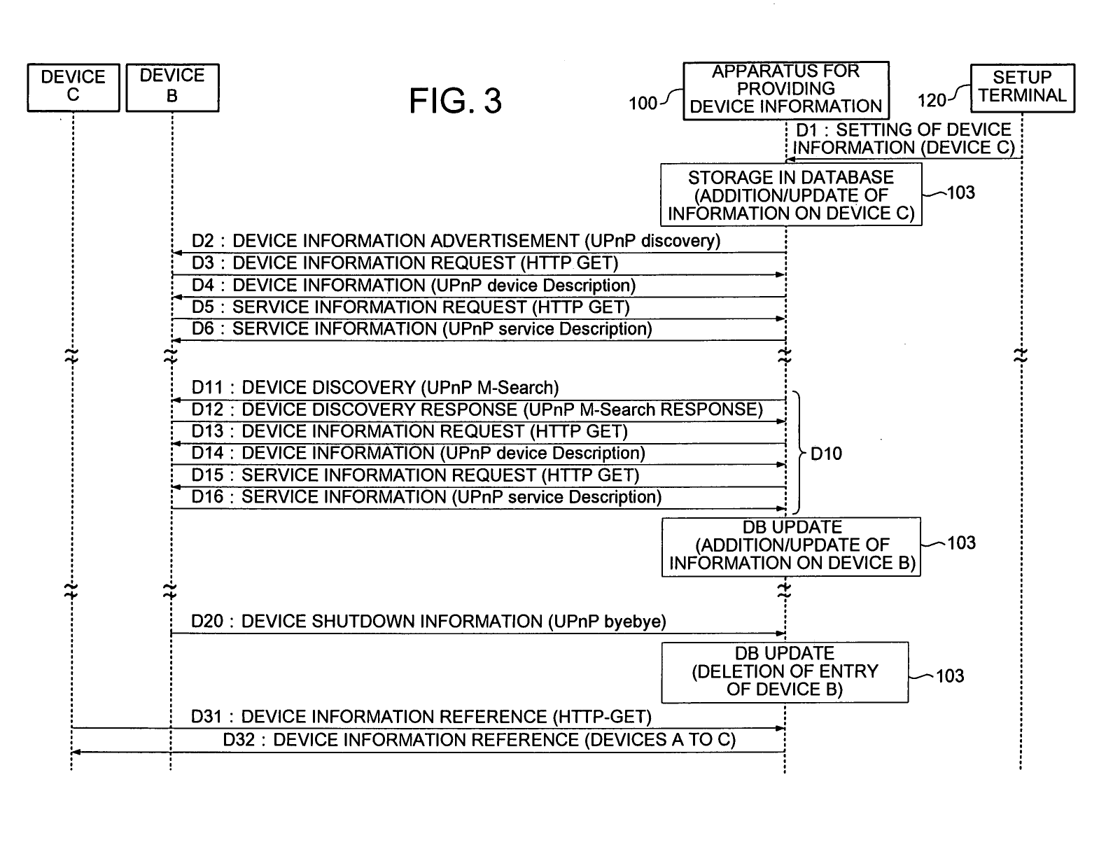

FIG. 3 is a sequence diagram of the operation to record and provide the device information according to the first embodiment. A user of the in-home network 110 accesses the apparatus 100 from the setup terminal 120, and inputs a setting D1 of the device information of the device C via the setup UI 101. For example, if a web server interface is used as the setup UI 101, the device information is input through a web browser of the setup terminal 120.

When new device information or an update of the device information is registered from the setup terminal 120, the apparatus 100 provides a device information advertisement D2 (UPnP discovery) in the form of a multicast packet to the device B to notify the device C statically registered as a virtual UPnP-compatible device.

The device B accesses a site based on URL information included in the device information advertisement D2 and issues a device information request D3 (HTTP GET) to obtain device information D4 (UPnP device description) of the device C. The device B can also access a site based on a service information URL (SCPDURL) included in-the device information D4 and issue a service information request D5 to obtain service information D6 (detailed information of service and function: UPnP service Description) of the device C. The device information D4 and the service information D6 of the device C are generated by the apparatus 100 based on the information that is statically registered via the setup UI 101 (see FIG. 1).

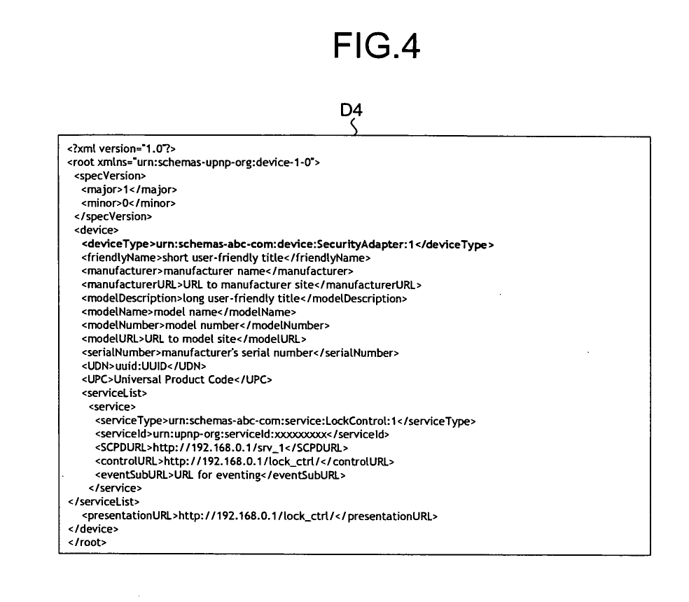

FIG. 4 is a schematic for illustrating the device information (device description). The device information is structured as shown in the device information D4. In the device information D4, the device type of the device C is informed as a security adapter, which does not exist in UPnP regulations. In the UPnP regulations, regulation of an original device type is permitted. A device code of a standard device is urn: schemas-upnp-org:device: . . . . Other items in the device information are set to the information that is input via the setup UI 101.

The apparatus 100 also periodically performs a discovery process D10 on the device B on the in-home network 110. The periodic device discovery process D10 is achieved by periodically issuing a UPnP-device discovery message D11 (M-Search). Upon receiving the UPnP-device discovery message D11, the device B outputs a device-discovery response message D12 (M-Search response) that includes the URL information of the device B based on the UPnP protocol.

The apparatus 100 accesses the URL included in the device-discovery response message D12 and issues a device information request D13 to obtain device information D14 of the device B. The apparatus 100 accesses the service information URL included in the device information D14, and issues a service information request D15 to obtain service information D16. Next, the apparatus 100 adds new device information or updates the device information.

When the device B is shut down, a device shutdown information message D20 (UPnP byebye) is output from the device B. The device shutdown information message D20 acts as a trigger and causes the apparatus 100 to delete an entry of the device B from the device information DB 103.

The device C performs a device information reference D31 (HTTP-GET) with respect to the apparatus 100 to obtain device information 32 of each of the devices B and C on the in-home network 110.

Thus, according to the first embodiment, it is possible to provide the device information of both the devices A and B that are automatic discovery protocol compatible and the devices C and D that are automatic discovery protocol incompatible on the in-home network 110.

In the first embodiment, even when the device information changes, a change is not reflected in the device information to be provided to the devices A to D. The apparatus 100 according to a second embodiment of the present invention periodically monitors the device information in the device information DB 103 and updates the database information if required. Furthermore, based on results of updating, the apparatus 100 provides updated device information to the devices A to D.

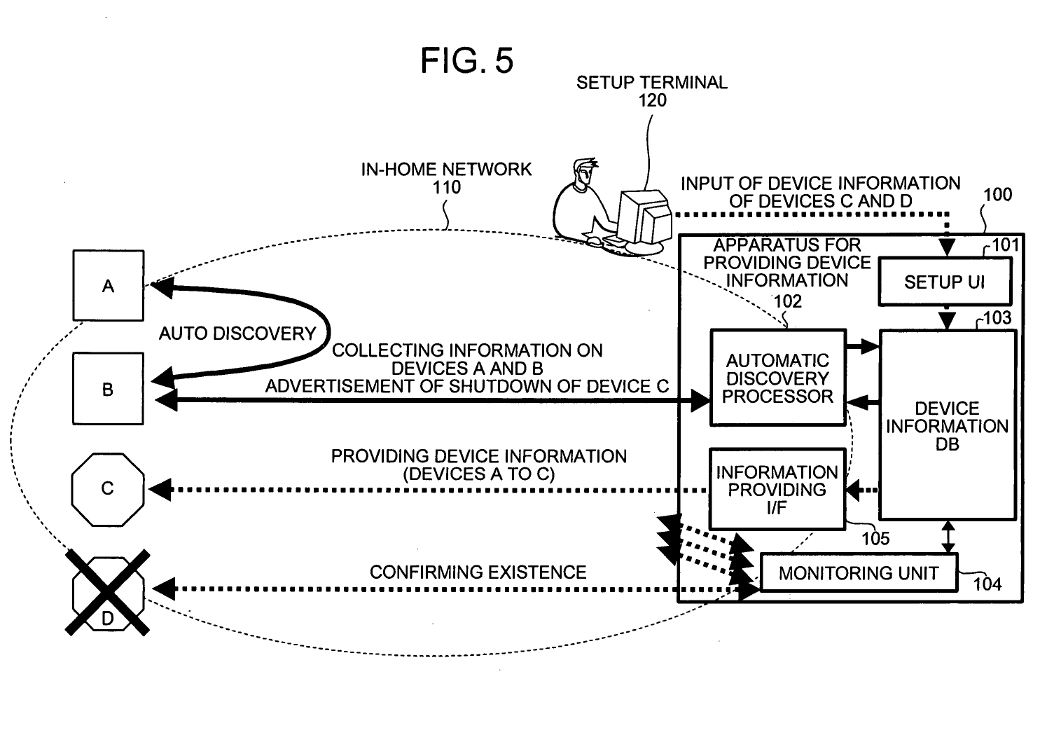

FIG. 5 is a schematic of an apparatus for providing device information according to the second embodiment. As shown in FIG. 5, the device information of the devices C and D is stored in the device information DB 103, and the UPnP incompatible device D is shut down.

The monitoring unit 104 periodically confirms existence of each of the devices A to D that are controlled by the device information DB 103. An operation to confirm the existence of the devices A to D by a common internet-control message protocol (ICMP) is explained next.

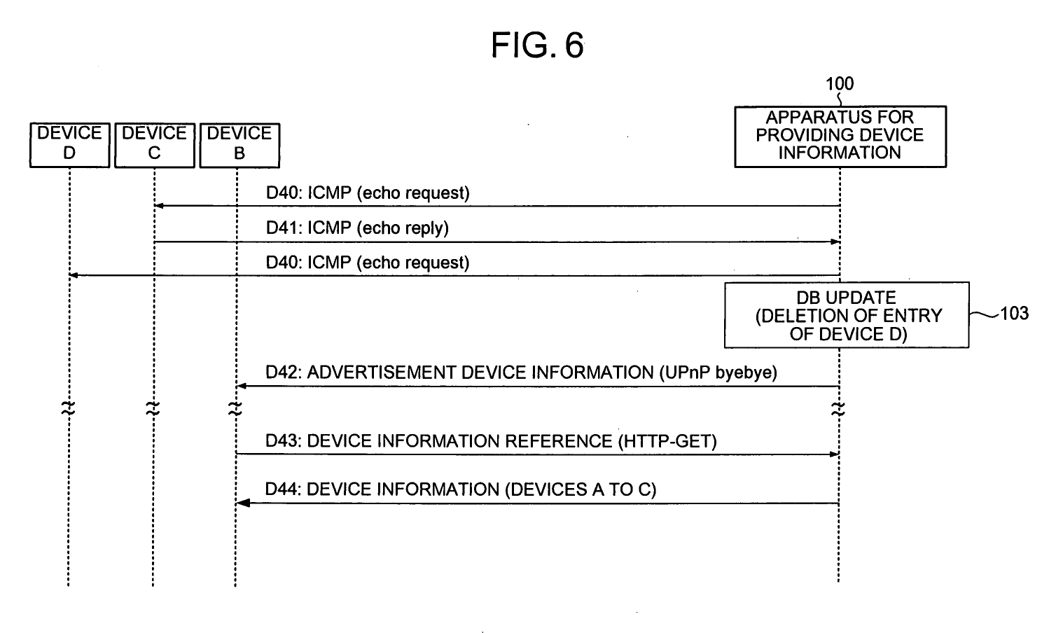

FIG. 6 is a sequence diagram of the operation to record and provide the device information according to the second embodiment. The apparatus 100 periodically sends an iCMP (echo request) message D40 to the devices C and D that are registered in the device information DB 103. For example, upon receiving the ICMP message D40, the device C that exists on the in-home network 110 responds with an ICMP (echo reply) message D41 based on the ICMP. The device D, which is shut down, does not respond with the ICMP (echo reply) message D41.

The apparatus 100 thus determines that the device D is shut down. The apparatus 100 deletes an entry of the device D to update the device information DB 103. Because the entry of the device D is deleted, the apparatus 100 generates a device information advertisement (UPnP byebye) message D42 and provides the device information announcement message D42 to the in-home network 110. Thus, the device B can recognize that the device D is shut down. Moreover, when the device C accesses the device information DB 103 via the information providing I/F 105 and performs a device information reference (HTTP-GET) D43, since device information D44 does not include the device information of the device D, the shutdown condition of the device D can be recognized.

According to the second embodiment, the apparatus 100 confirms the existence of the devices that registered in the device information DB 103, and if the existence of a device cannot be confirmed, deletes the device information of the device from the device information DB 103. Thus, unnecessary device information is not provided to other devices, and the devices A to D can receive device information of only the devices A to D that are currently usable.

In the second embodiment, when the D is shut down, the entry of the device information of the device D is deleted. Due to this, when the UPnP incompatible device D is turned on to be alive again, the device information of the device D needs to be input again via the setup UI 101. In an apparatus for providing device information according to a third embodiment of the present invention, such re-registration of the device information is not required.

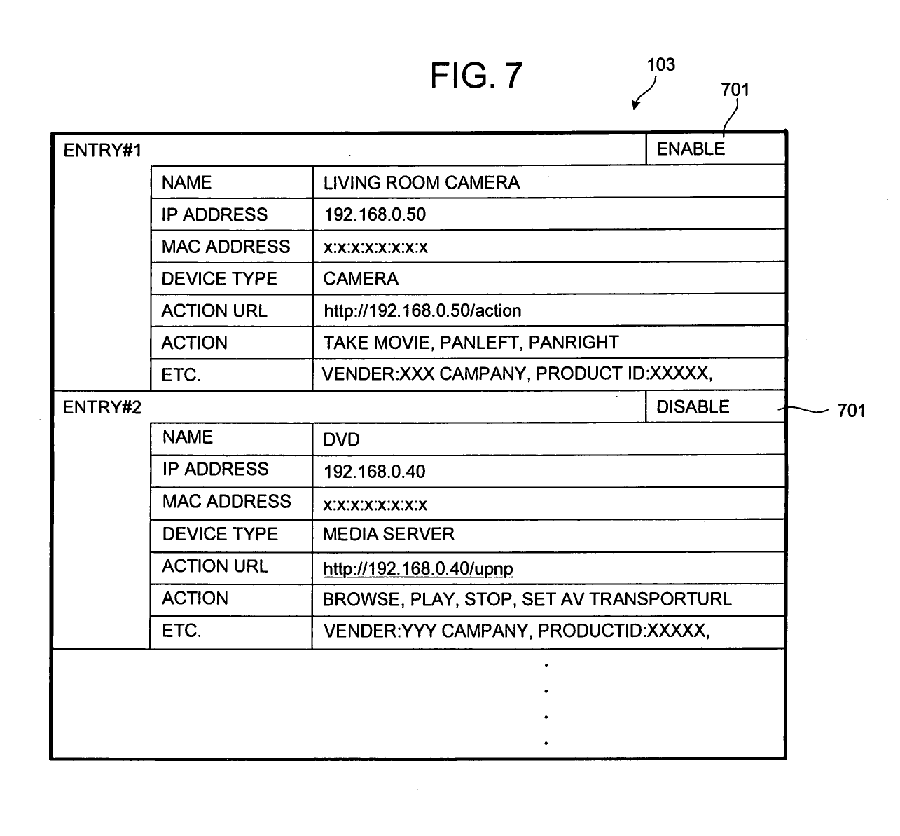

FIG. 7 is a table of device information stored in the device information database. As shown in FIG. 7, in the device information DB 103, a flag 701 that indicates whether the entry is valid (Enable) or invalid (Disable) is provided for each entry of the device information. The monitoring unit 104 confirms existence of a device based on ICMP in a similar manner as in the second embodiment.

The apparatus 100, upon detecting a shutdown state of the device D, sets the flag 701 to invalid and nullifies the entry of the device D. The apparatus 100 notifies the shutdown state of the device D to the device B by the device information advertisement (UPnP byebye) message D42. Moreover, when the device information is referred through the information providing I/F 105, the entry in the device information DB 103 of the device D having the invalid flag 701 is not displayed. Thus, the shutdown state of the device D can be notified to the device B and the device C.

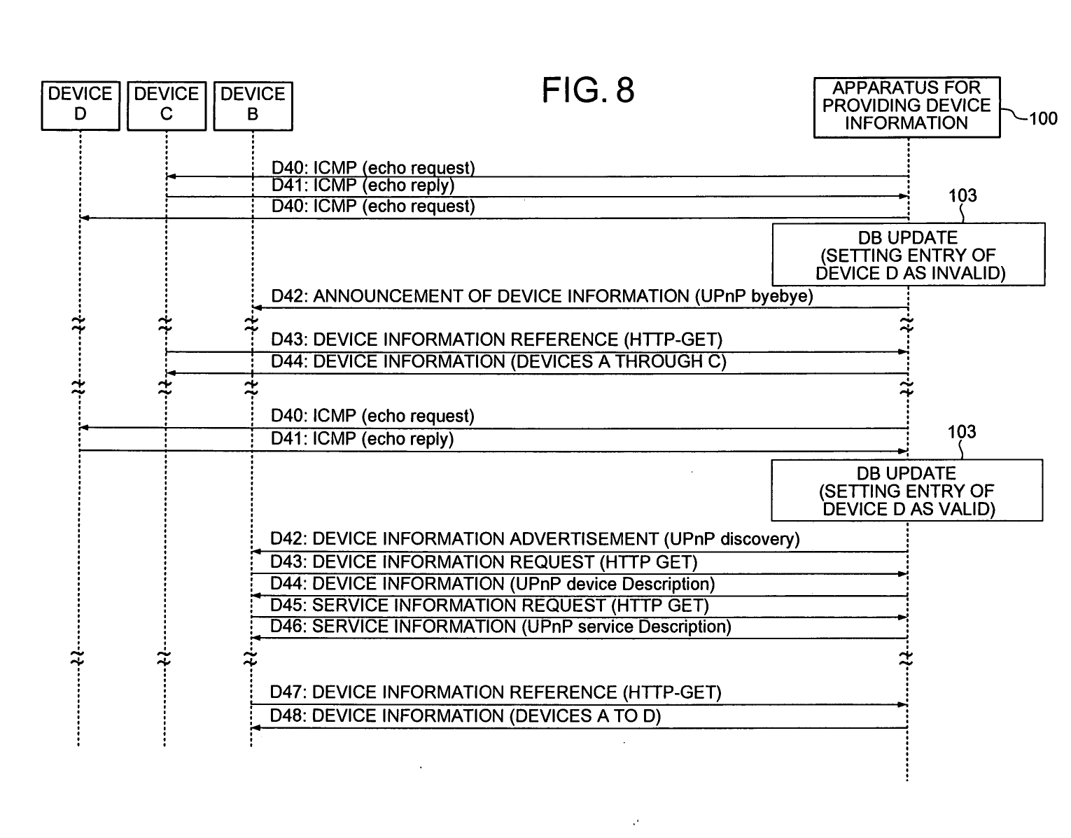

FIG. 8 is a sequence diagram of an operation to record and provide the device information according to a third embodiment of the present invention. In the third embodiment, a periodic monitoring of the device D, which is in the invalid condition, is maintained. Therefore, when the device D becomes alive again and responds with the ICMP (echo reply) message D41, the monitoring unit 104 of the apparatus 100 confirms the existence of the device D. The flag 701 is changed to indicate the valid condition in the device information DB 103 for the device D. The apparatus 100 outputs the device information D44 and service information D46 of the device D by the device information advertisement (UPnP discovery) message D42. Thus, the device information of the device D can be provided again to the device B.

Because the device D becomes valid, the device C, when carrying out device information reference (HTTP-GET) D47 and accessing the device information DB 103 via the information providing I/F 105, can obtain device information D48 of the device D.

Thus, according to the third embodiment, when a state of the device D changes from the shutdown state to an alive state, the device information of the device D can be provided to the devices A to D without re-setting the device information via the setup UI 101.

In the third embodiment, the device information DB 103 is periodically monitored to confirm consistency between the device information in the device information DB 103 and actual device information, and if the device information in the device information DB 103 does not match with the actual device information, the device information DB 103 is updated to the latest device information. Furthermore, the latest device information is provided to the devices A to D on the in-home network 110 base on the automatic discovery protocol.

If the devices A to D are operating in a dynamic host configuration protocol (DHCP) environment (in which a terminal address is automatically assigned), the IP addresses of the devices A to D change when the devices A to D are activated. In such environment, inconsistency between the device information in the device information DB 103 and the actual device information is occurs every time the devices A to D are activated. This leads to providing old or invalid device information to the devices A to D. According to a fourth embodiment of the present invention, the device information is updated according to a change of the IP address.

The monitoring unit 104 periodically checks the IP addresses of the devices A to D that are registered in the device information DB 103. The IP address and the MAC address of the devices A to D are managed in the device information DB 103 for each of the devices A to D. The IP address of each of the devices A to D may be changed every time each of the devices A to D is activated in the DHCP environment while the MAC address is basically constant and not changed. Using this characteristic, the IP addresses are confirmed based on an address resolution protocol (ARP). The ARP is a protocol to obtain the MAC address corresponding to the IP address.

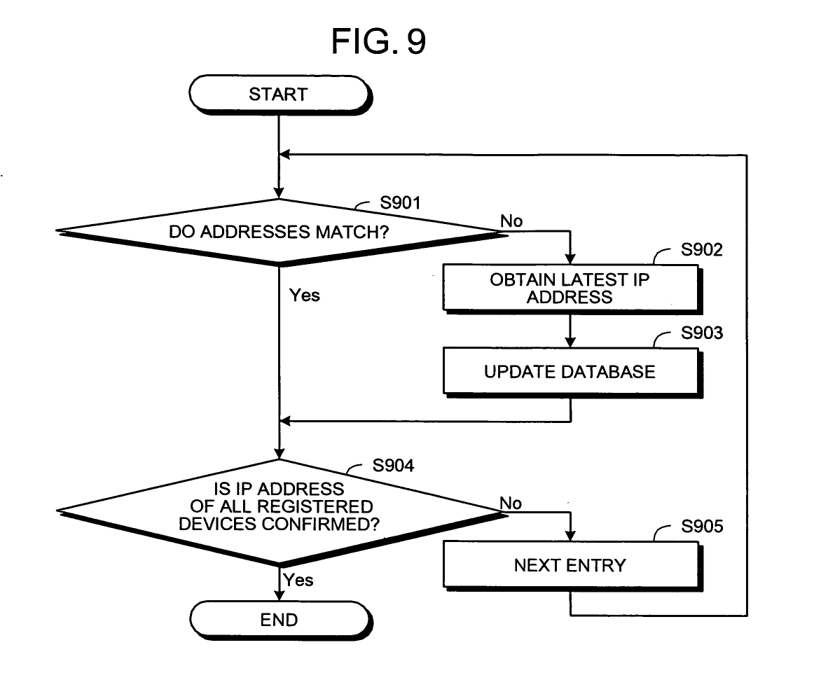

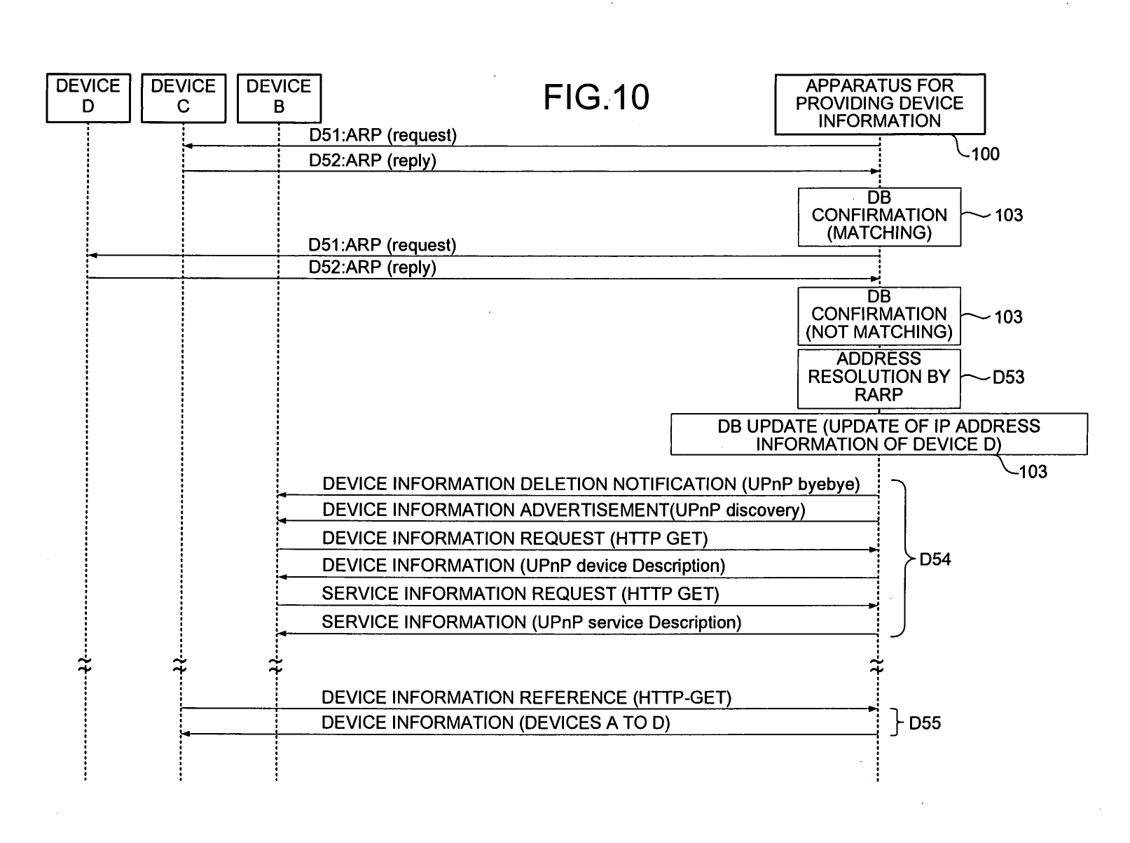

FIG. 9 is a flowchart of an address monitoring process according to the fourth embodiment. FIG. 10 is a sequence diagram of an operation to update the device information according to the fourth embodiment. The apparatus 100 sends an ARP request related to the IP address of the devices A to D registered in the device information DB 103 (D51 shown in FIG. 10). Next, the device indicated by the IP address included in the ARP request (the devices C and D shown in FIG. 10) returns an ARP response (D52 shown in FIG. 10). The apparatus 100 determines, based on a result of address confirmation, whether the device information in the device information DB 103 matches with the actual database information. In other words, the apparatus 100 checks whether the IP address and the MAC address included in the ARP response of the devices A to D match with the IP address and the MAC address in the device information DB 103 respectively (step S901). If the addresses match each other (“YES” at step S901), the apparatus 100 determines that the device information is registered properly and proceeds to step S904.

If the addresses do not match, or if the ARP response message cannot be received (“NO” at step S901), the apparatus 100 determines that the IP address is changed and obtains the latest IP address (step S902).

Because the MAC address is constant, the latest IP address is obtained based on a reverse ARP (RARP) (D53 shown in FIG. 10). The RARP is a protocol to obtain the IP address corresponding to the MAC address. When a correspondence between the IP address and the MAC address is not matching, an RARP message including the MAC address is sent to the in-home network 110. The devices A to D having the MAC address or an RARP server (a server that responds instead of the devices A to D if the RARP is not supported by the devices A to D) sends an RARP response message, which includes the IP address corresponding to the MAC address, to the apparatus 100.

The apparatus 100, upon receiving the RARP response message, determines that the IP address included in the RARP response message is the latest IP address, and updates the information corresponding to the IP address in the device information DB 103 (step S903). Based on the latest information, the apparatus 100 provides the device information of the devices A to D to the devices A to D on the in-home network 110 via the UPnP message and the information providing I/F 105. D54 and D55 shown in FIG. 10 correspond to this process. Except for a device information deletion advertisement (UPnP byebye) in D54, D54 is similar to D42 to D46 shown in FIG. 8. D55 is similar to D47 and D48 shown in FIG. 8.

Next, the apparatus 100 determines whether the IP addresses of all of the devices A to D registered have been confirmed (step S904 of FIG. 9). If the IP addresses of all the devices A to D have been confirmed (“YES” at step S904), a first monitoring process is finished. If the IP address of any one of the devices A to D has not yet been confirmed (“NO” at step S904), the apparatus 100 starts to monitor the next entry among the entries in the device information DB 103 (step S905) and again executes the process shown in FIG. 9 from step S901.

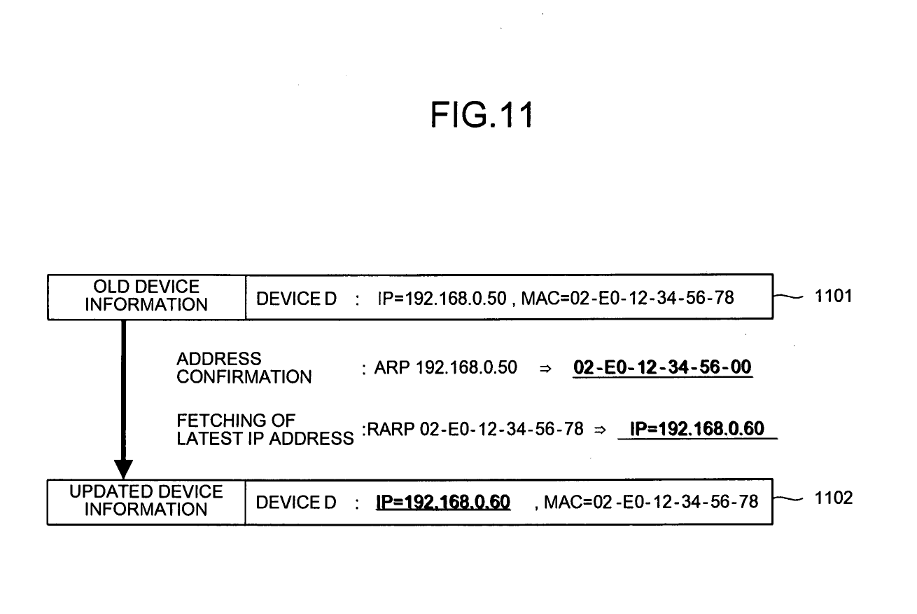

FIG. 11 is schematic for illustrating update of information in the device information DB 103. In information 1101 of the device D, the IP address is 192.168.0.50 and the MAC address is 02-EO-12-34-56-78.

The apparatus 100 determines whether the addresses match the addresses obtained through the address confirmation at step S901 shown in FIG. 9. If the MAC address included in the ARP response message differs from the MAC address of the information 1101 (for example, if MAC address is 02-EO-12-34-56-00 when the ARP is 192.168.0.50, or if there is no response), the apparatus 100 obtains the latest IP address at step S902. If IP address 192.168.0.60 is returned as the IP address corresponding to MAC address 02-EO-12-34-56-78 specified in the RARP response message, the device information DB 103 updates the IP address to the latest IP address to form information 1102 having IP address 192.168.0.60 and MAC address 02-EO-12-34-56-78 at step S903.

According to the fourth embodiment, the apparatus 100 automatically updates the device information of the devices A to D even if the IP addresses of the devices A to D on the in-home network 110 change at each activation. Thus, re-registration of the device information by the user becomes unnecessary and the latest device information can be provided to the devices A to D.

In the apparatus 100 according to the first to fourth embodiments, the user manually inputs the various items when inputting the device information of the devices C and D, which are UPnP incompatible, via the setup UI 101. It is extremely difficult for an ordinary user to input the detailed setup data.

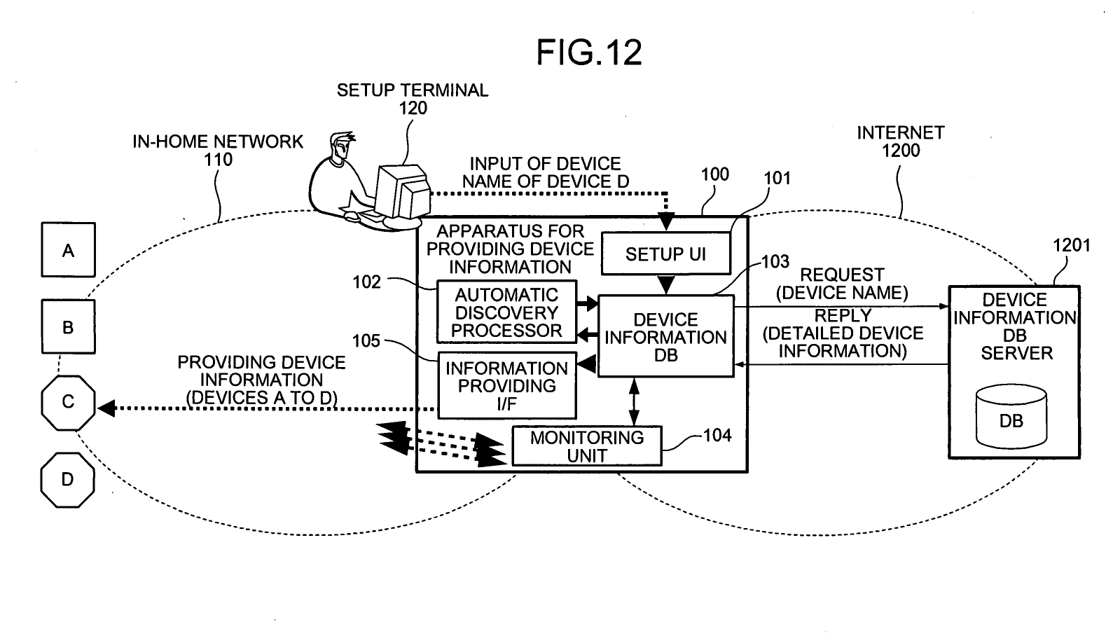

FIG. 12 is schematic of an apparatus for providing device information according to a fifth embodiment of the present invention. The user inputs information on only simple items, such as manufacturer and device name, from the setup terminal 120. A searching unit (not shown) is connected to a network such as Internet 1200 and accesses a device information DB server (a device setup information server on the network) 1201 that is connected to the Internet 1200 and holds the device information. The detailed device information on the device D is obtained from the device information DB server 1201 based on the information of the simple items (using as a search key) that are input by the user. The detailed device information obtained is stored in the device information DB 103.

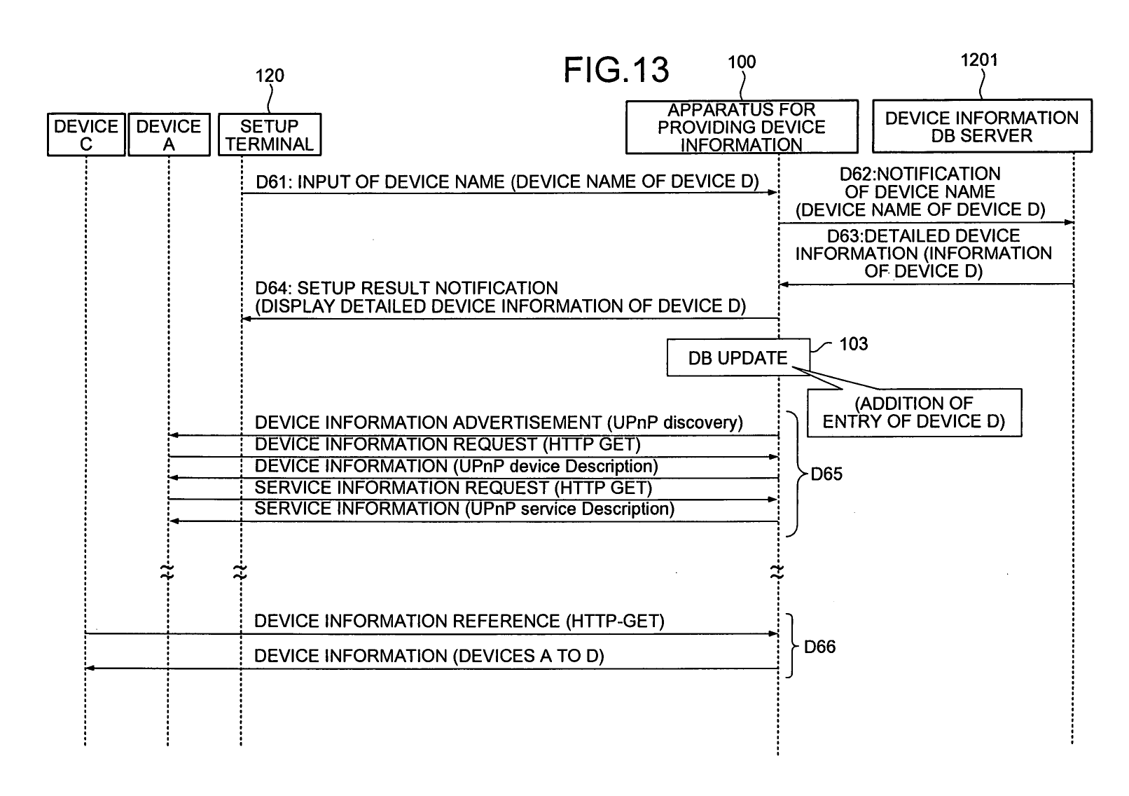

FIG. 13 is a sequence diagram of an operation to record and provide the device information according to the fifth embodiment. The user inputs a device name (the device name of the device D in the example shown in FIG. 13) into the apparatus 100 from the setup terminal 120 (D61). Next, the apparatus 100 accesses the device information DB server 1201 via the Internet 1200 and notifies the device name (D62). The device information DB server 1201 provides the detailed device information (detailed device information D63) of the device corresponding to the device name to the apparatus 100.

The apparatus 100 performs a setup result notification (D64) to the setup terminal 120 and stores the detailed device information in the device information DB 103. Thus, the detailed device information of the device D can be provided to the devices A to D on the in-home network 110. The device information of the devices A to D is provided to the devices A to D via the UPnP message and the information providing I/F 105 (D65 and D66). D65 is similar to D42 through D46 shown in FIG. 8 and D66 is similar to D47 and D48 shown in FIG. 8.

Thus, according to the fifth embodiment, the complicated input operations by the user can be simplified. Moreover, in the fifth embodiment, the detailed device information obtained from the device information data DB server 1201 via the Internet 1200 in response to the simple entries input by the user is notified to the user. A setup file of the device may be downloaded beforehand from the device information DB server 1201 on the Internet 1200 by the setup terminal 120 and the downloaded file can be uploaded by the setup UI 101, thereby omitting the operations required for manual input by the user.

The apparatus 100 collectively manages the device information of the devices A to D on the in-home network 110 and grasps the device information on all of the devices A to D on the in-home network 110. Using the device information, services such as remote automatic upgrading of the firmware of the devices A to D or remote access to the devices A to D becomes possible.

However, if the device information of all of the devices A to D on the in-home network 110 is made freely accessible, this can result in leakage of personal information.

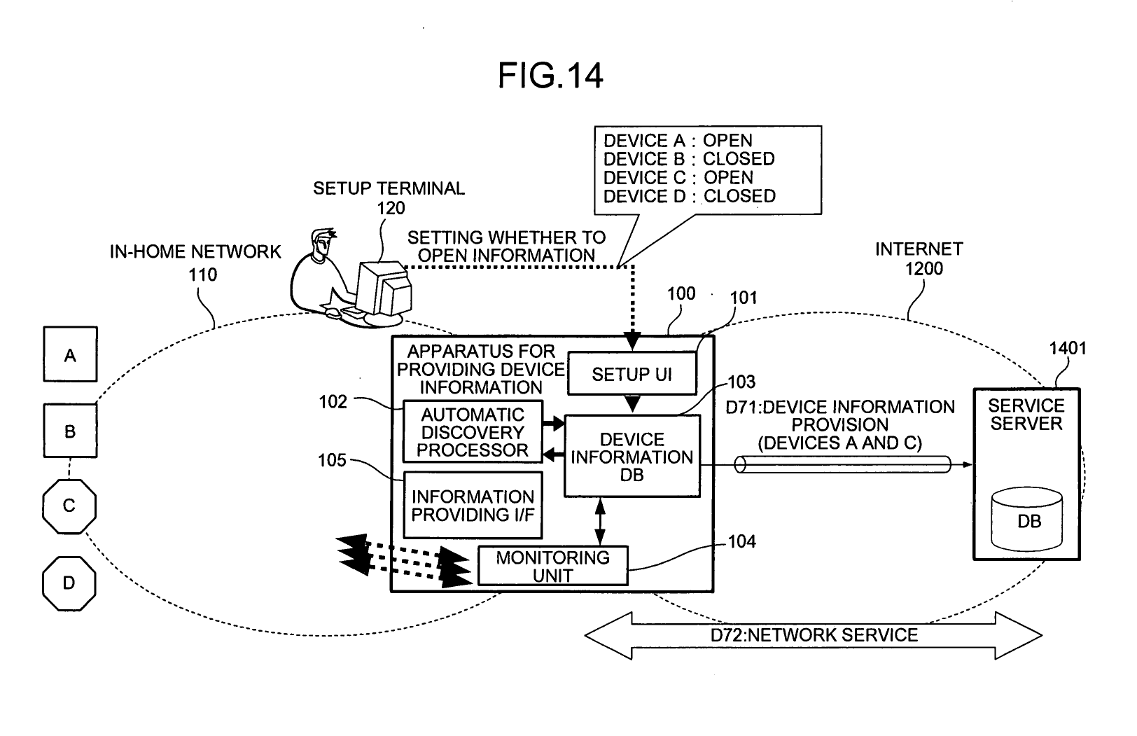

FIG. 14 is a schematic of a structure of an apparatus for providing device information according to a sixth embodiment of the present invention. The user randomly specifies whether to open the device information from the setup terminal 120. Thus, the device information of each of the devices A to D is determined whether to be open or closed on a network. The apparatus 100 sends device information provision (D71) to provide only the device information that is determined to be open by the user (the devices A and C in the example shown in FIG. 14) to a service server 1401 on a network such as the Internet 1200 by a secure communication bus. Various network services (D72) for the devices A to D on the in-home network 110 can be provided based on open device information provided.

According to the sixth embodiment, the apparatus 100 can set whether to make the device information open to external devices via a network other than the in-home network 110, such as the Internet 1200. Thus, only the necessary device information of the devices A to D can be made open to the external source, thereby enabling to prevent leakage of personal information as well as the device information A to D. Thus, information security is enhanced.

With the method and the apparatus for providing device information, both the devices A and B, which are UPnP compatible, and the devices C and D, which are UPnP incompatible, can obtain the device information of all of the devices A to D arranged on the in-home network 110. The device information of the devices C and D can also be automatically updated according to a change in the condition of the devices. By providing a protocol conversion function, the devices C and D can receive the device information of the devices A and B and vice versa.

The method of providing device information explained in the embodiments of the present invention can be implemented by executing a computer program prepared in advance by a computer, such as a personal computer and a workstation. The computer program is recorded on a computer-readable recording medium, such as a compact-disk read-only-memory, a magneto-optical disk, and a digital versatile disk, and is executed by the computer reading out from the recording medium. The computer program may be a transmission medium that is distributed through a network such as the Internet.

According to the present invention, it is possible to provide device information of all of devices arranged on a network to both an automatic-discovery-process compatible device and an automatic-discovery-process incompatible device.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing device information on devices arranged on a network, the devices including a first device and a second device, wherein the first device does not support an automatic discovery scheme with which a device on the network is automatically discovered and the second device supports the automatic discovery scheme, the apparatus comprising:
a registering unit configured to register device information on the first device;
a discovering unit configured to discover the second device, and to obtain device information on the second device; and
a providing unit configured to provide the device information on the first device, to the second device.

2. The apparatus according to claim 1, wherein the providing unit is configured to provide, based on a request from the first device, the device information to the first device.

3. The apparatus according to claim 1, further comprising:
a database configured to store the device information; and
a monitoring unit configured to monitor correctness of the device information in the database, and to update the device information in the database based on a result obtained by monitoring, wherein
the providing unit is configured to provide updated device information to the devices.

4. The apparatus according to claim 3, wherein the monitoring unit is configured to monitor whether the devices are alive, and to delete, from the database, an entry of a device that is not alive when the device not alive is detected as a result of monitoring.

5. The apparatus according to claim 3, wherein
the device information in the database includes state information on a state of each of the devices, and
the monitoring unit is configured to monitor a shutdown and a start of the devices and to update the state information based on a result of monitoring the shutdown and the start.

6. The apparatus according to claim 3, wherein
the device information in the database includes an internet protocol address and a medium-access-protocol address of each of the devices, and
the monitoring unit is configured to detect the internet protocol address and the medium-access-protocol address of the devices on the network, and to update the internet protocol address and the medium-access-protocol address in the database based on result of detection.

7. The apparatus according to claim 1, further comprising
an acquiring unit configured to acquire detailed information on the first device via a second network, wherein
the registering unit is configured to receive simple information on the first device from an external device present in the network, and
the detailed information is acquired based on the simple information.

8. The apparatus according claim 1, wherein the registering unit is configured to determine, for each of the devices, whether to open the device information to external devices, and configured to provide device information determined to be open to the external devices.

9. A method of providing device information on devices arranged on a network, the devices including a first device and a second device, wherein the first device does not support an automatic discovery scheme with which a device on the network is automatically discovered and the second device supports the automatic discovery scheme, the method comprising:
registering device information on the first device;
discovering the second device;
obtaining device information on the second device; and
providing the device information on the first device to the second device.

10. The method according to claim 9, wherein the providing includes providing, based on a request from the first device, the device information to the first device.

11. The method according to claim 9, further comprising:
storing the device information in a database; and
monitoring correctness of the device information in the database;
updating the device information in the database based on a result obtained at the monitoring, wherein
the providing includes providing updated device information to the devices.

12. The method according to claim 11, wherein the monitoring includes
monitoring whether the devices are alive; and
deleting, from the database, an entry of a device that is not alive when the device not alive is detected as a result of monitoring.

13. The method according to claim 11, wherein
the device information in the database includes state information on a state of each of the devices, and
the monitoring includes
monitoring a shutdown and a start of the devices; and
updating the state information based on a result of monitoring the shutdown and the start.

14. The method according to claim 11, wherein
the device information in the database includes an internet protocol address and a medium-access-protocol address of each of the devices, and
the monitoring includes
detecting the internet protocol address and the medium-access-protocol address of the devices on the network; and
updating the internet protocol address and the medium-access-protocol address in the database based on result of detection.

15. The method according to claim 9, further comprising
acquiring detailed information on the-first device via a second network, wherein
the registering includes receiving simple information on the first device from an external device present in the network, and
the detailed information is acquired based on the simple information.

16. The method according claim 9, wherein the registering includes
determining, for each of the devices, whether to open the device information to external device; and
providing device information determined to be open to the external devices.
